(19) United States
(12) Patent Application Publication
(10) Pub. No.: US 2019/0333382 A1
(43) Pub. Date: Oct. 31, 2019

(54) METHOD AND DEVICE FOR INTERACTING WITH A LOCAL GUIDANCE SYSTEM IN A MOTOR VEHICLE

(71) Applicant: Robert Bosch GmbH, Stuttgart (DE)

(72) Inventors: Andreas Heyl, Sunnyvale, CA (US); Ralf Becker, Schwieberdingen (DE)

(21) Appl. No.: 16/344,162

(22) PCT Filed: Oct. 4, 2017
(86) PCT No.: PCT/EP2017/075122

§ 371 Date: Apr. 23, 2019

(30) Foreign Application Priority Data
Nov. 15, 2016 (DE) 10 2016 222 421.2

(51) Int. Cl. G08G 1/0967; H04W 4/44; H04W 4/024; G01C 21/34

(52) U.S. Cl. CPC G08G 1/096716; H04W 4/44; G01C 21/3492; G08G 1/096725; G08G 1/096783; H04W 4/024

(57) ABSTRACT

A method for the interaction of a driver assistance system in a motor vehicle with a local guidance system, including identifying an area having local traffic routing; downloading a guidance system application or parameters for an existing guidance system application in order to create a communication interface with the local guidance system that is associated with the identified area of local traffic routing; using the communication interface for the communication of the driver assistance system with the local guidance system if the motor vehicle is located within the area having the local traffic routing.

### FIELD

The present invention relates to driver assistance systems for motor vehicles, in particular driver assistance systems that are able to communicate with local guidance systems.

### BACKGROUND INFORMATION

Navigation systems for route planning normally use publicly available map data in order to ascertain an optimized route between a current location of a motor vehicle and a specified destination. The publicly available map data normally contain all public routes that may be navigated by a vehicle, but do not contain information that is sufficiently precise for lateral guidance and/or information about local routes in buildings such as parking garages, distribution centers, national parks, private lands or the like.

For such local traffic routing, normally no map data are available that could be integrated into the public route network, particularly since conventional navigation based on GPS position-finding is not possible in parking garages.

Instead, guidance systems may be implemented for local traffic routing, which suitably communicate with the motor vehicle via V21, for example, and transmit local information such as driving recommendations or control interventions up to and including the complete remote control of the motor vehicle. To communicate with such a guidance system, a corresponding driver assistance system therefore requires a suitable interface that must be present already originally in the delivery state of the motor vehicle or that can be retrofitted.

A method for requesting guidance information for a parking option including a charging option for an electric vehicle is described in German Patent Application No. DE 10 2011 088 809 A1. For this purpose, the electric vehicle transmits a request signal for requesting guidance information using an additional requirement and a location and a range of the electric vehicle.

### SUMMARY

The present invention provides a method for operating a driver assistance system for interacting with a guidance system in a motor vehicle, as a driver assistance system and a motor vehicle.

Additional developments of the present invention are described herein.

According to a first aspect of the present invention, an example method is provided for the interaction of a driver assistance system in a motor vehicle with a local guidance system, having the following steps:
identifying an area having local traffic routing;
downloading a guidance system application or parameters for an existing guidance system application in order to create a communication interface with the local guidance system that is associated with the identified area having local traffic routing;
using the communication interface for the communication of the driver assistance system with the local guidance system if the motor vehicle is located within the area having local traffic routing.

In accordance with the present invention, the driver assistance system is provided with a data processing unit that makes it possible to download a guidance system application in response to a manual or automatic request in order thus to provide a communication interface that allows for communication with a local guidance system. This makes it possible for the guidance system to provide driving recommendations for local traffic routing and/or to move the vehicle autonomously along the local traffic route.

Thus, it is possible for example to provide or start a guidance system application automatically or upon request. For example, in the case of a parking garage, a vehicle may be driven upon request autonomously and without a driver via local traffic routing in the parking garage in order to park it there and upon request unpark it again and to provide the vehicle at a specified location. The lateral guidance is provided by a guidance system belonging to the parking garage, which is able to communicate with the motor vehicle via the interface provided by the guidance system application.

Furthermore, in accordance with the present invention, downloading the guidance system application or the parameters for an existing guidance system application may be performed by a data storage unit outside the vehicle, which is developed separately from the guidance system or is provided in the guidance system.

In accordance with the present invention, there may be a provision for the identification of an area having local traffic routing to be performed on the basis of a destination specification in a navigation system or on the basis of a currently traveled route or a current position of the vehicle.

Furthermore, in accordance with the present invention, the guidance system application may be downloaded automatically without asking the driver or after a prior confirmation on the part of the driver, and when crossing a minimum distance en route to the area of local traffic routing, immediately after entering the area of local traffic routing or at the start of the drive to a known destination where the area of local traffic routing is located.

According to one specific embodiment of the present invention, the guidance system application can only be downloaded when it is determined that there exists no interface to the guidance system of the identified area having local traffic routing.

In accordance with the present invention, there may be a provision that the use of the communication interface makes it possible automatically to signal to the driver driving recommendations or to move the vehicle in fully automatic fashion along the local traffic routes.

In accordance with the present invention, if it is determined that the motor vehicle has left the area of local traffic routing, the guidance system application may be automatically uninstalled from the driver assistance system.

According to another aspect of the present invention, an example device is provided, in particular a driver assistance system, in a motor vehicle for interaction with a local guidance system, the device being designed to:
identify an area having local traffic routing;
download a guidance system application or parameters for an existing guidance system application in order to create a communication interface with the local guidance system that is associated with the identified area having local traffic routing;
use the communication interface for the communication of the driver assistance system with the local guidance system if the motor vehicle is located within the area of local traffic routing.

### BRIEF DESCRIPTION OF THE DRAWINGS

Specific embodiments are explained in greater detail below on the basis of the figures.

FIG. 1 shows a schematic representation of a motor vehicle having a driver assistance system.

FIG. 2 shows a flow chart for illustrating a method for operating a driver assistance system in a motor vehicle.

### DETAILED DESCRIPTION OF EXAMPLE EMBODIMENTS

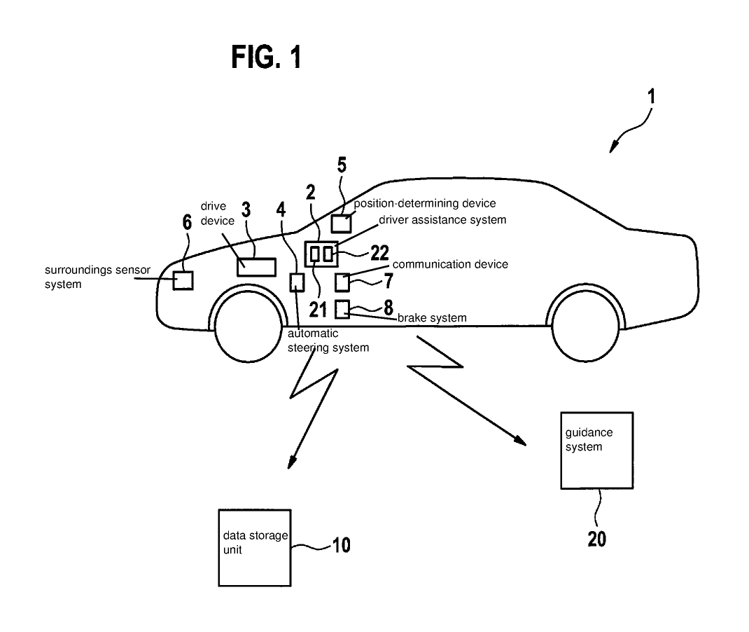

FIG. 1 shows a schematic representation of a motor vehicle 1 which has a driver assistance system 2. Driver assistance system 2 is connected to a drive device 3 and a brake system 8 for driving and, respectively, braking motor vehicle 1, an automatic steering system 4 for performing autonomous steering interventions.

Furthermore, a position-determining device 5, in particular in the form of a GPS unit or the like, may be provided in order to detect a current vehicle position. Alternatively, position-determining device 5 may also be located outside of the vehicle (e.g., position determination via external cameras) and the position or trajectory or the control commands may be transmitted to motor vehicle 1.

Furthermore, a surroundings sensor system 6 is provided in order to detect and identify object in the surroundings of the vehicle in a suitable manner, e.g. with the aid of radar, LiDAR, ultrasonic sensors, cameras and the like. Driver assistance system 2 has a data processing device 21, which is able to execute applications that are stored in an application storage unit 22.

Via a communication device 7 as a communication interface, driver assistance system 2 is in communication connection with a data storage unit 10 situated outside of motor vehicle 1 or is able to establish a communication connection to data storage unit 10. Data storage unit 10 contains retrievable data, in particular software applications, map data or the like.

Furthermore, motor vehicle 1 is able to communicate with a guidance system 20 via communication device 7. The local guidance system 20 is used for local traffic routing of motor vehicle 1 and normally requires a proprietary interface in motor vehicle 1. Guidance system 20 is to communicate with motor vehicle 1 in such a way that guidance system 20 upon request is able to transmit data about driving recommendations to driver assistance system 2 or is able to take over the remote control over motor vehicle 1 entirely or partially.

In order to provide the proprietary interface, communication device 7 may be used to download from data storage unit 10 a suitable guidance system application as a software interface for the specific local guidance system 20, which may be executed in data processing device 21. This makes it possible for driver assistance system 2 to receive the interface via which it is able to communicate with local guidance system 20 and is able to execute in motor vehicle 1 the functions provided in accordance with local guidance system 20. Data storage unit 10 may also be integrated into guidance system 20 so that guidance system 20 provides the guidance system application on demand.

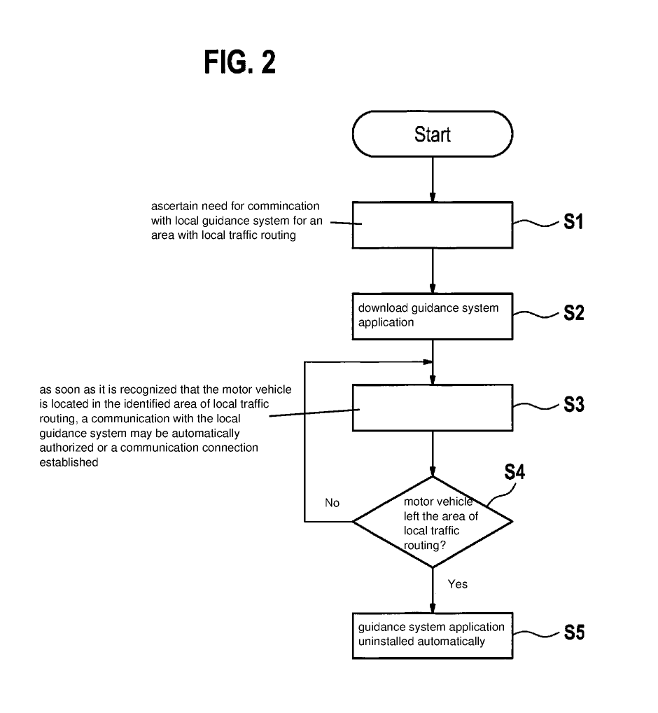

FIG. 2 shows a flow chart that describes a method that is executed in data processing device 21 of driver assistance system 2.

In step S1, a need for communication with a local guidance system 20 is ascertained for an area with local traffic routing. This may be done on the basis of a destination specification in a navigation system or based on a currently traveled route and/or as a function of the current vehicle position. The area having the local traffic routing may be for example a parking garage, a national park, a distribution center or the like, and may be accessible to motor vehicles. Furthermore, the area for local traffic routing may also be a public roadway, which is instrumented by a guidance system for autonomous driving. The area of local traffic routing is supplied by guidance system 20 for providing a locally limited traffic routing, which is not contained in publicly available map data for navigation systems.

Thus it is possible to detect a need for communicating with a local guidance system 20 at a destination of the navigation or in an area which motor vehicle 1 is expected to enter or has already entered or will enter shortly (i.e. motor vehicle 1 is located at a specified distance away from the area of local traffic routing and approaches it).

In accordance with the identified area of local traffic routing, a guidance system application may now be downloaded in step S2 via a data connection to external data storage unit 10, which allows for communication with a local guidance system 10 of the identified area of local traffic routing.

The guidance system application may be downloaded
automatically without asking the driver or after prior confirmation from the driver, and
when crossing a minimum distance en route to the area of local traffic routing, immediately when entering the area of local traffic routing, or at the beginning of the drive having a known destination at which the area of local traffic routing is located.

There may be a provision for driver assistance system 2 to perform a prior check to determine whether an interface to guidance system 20 of the identified area already exists. This may be done by emitting an interface-specific test signal, to which guidance system 20 may react accordingly if it is compatible with the interface associated with the test signal. If it is ascertained that a corresponding interface for communicating with guidance system 20 of the identified area already exists, the step of downloading the guidance system application for guidance system 20 of the identified area may be skipped.

In step S3, as soon as it is recognized that the motor vehicle is located in the identified area of local traffic routing, a communication with the local guidance system 20 may be automatically authorized or a communication connection established.

The communication with local guidance system 20 makes it possible to transmit information to motor vehicle 1 that makes it possible for driver assistance system 2 automatically to signal driving recommendations to the driver or to move motor vehicle 1 in fully automatic fashion along local traffic routes. Thus it is possible, for example, for the local guidance system 20 to drive a motor vehicle autonomously and without a driver to a parking space in a parking garage, to park it there, and to unpark it again and to move it to a pickup point within the area of local traffic routing.

If guidance system 20 guides motor vehicle 1 autonomously, then guidance system 20 is able to obtain, via driver assistance system 2, access to drive unit 3, brake system 8, steering system 4 and surroundings detection sensor system 6 in order thus to allow for an autonomous operation of the motor vehicle along the local traffic routes. In particular within closed spaces, in which there is no satellite reception, the position of the motor vehicle controlled by the guidance system may be determined with the aid of other position-determining methods such as triangulation, camera-based or the like both within the vehicle as well as outside the vehicle.

If it is determined in step S4 that the motor vehicle has left the area of local traffic routing (alternative: yes), then the method is continued with step S5, otherwise (alternative: no) the method reverts to step S3.

In step S5, the guidance system application may be uninstalled automatically. This step may be provided optionally.

The guidance system application may be a separate software application, but may also be an adaptation or configuration of guidance system software already existing in the vehicle or of an interface already existing in the vehicle for communicating with guidance system 20. A deinstallation of the guidance system application may correspond to a reconfiguration to the previously existing parameter state.

The guidance system application already existing in motor vehicle 1 may exist for example in the form of a parking assistant application, which in communication with guidance system 20 transmits the vehicle-internal signals and data of the surroundings detection sensor system to guidance system 20 so that local guidance system 20 is able to take over the corresponding control of motor vehicle 1.

1-10. (canceled)

11. A method for the interaction of a driver assistance system in a motor vehicle with a local guidance system, comprising:
identifying an area having local traffic routing;
downloading a guidance system application or parameters for an existing guidance system application to create a communication interface with the local guidance system that is associated with the identified area of local traffic routing; and
using the communication interface for communication of the driver assistance system with the local guidance system when the motor vehicle is located within the area having local traffic routing.

12. The method as recited in claim 11, wherein the downloading of the guidance system application or the parameters for an existing guidance system application is performed by a data storage unit outside the vehicle, which is developed separately from the guidance system or is provided in the guidance system.

13. The method as recited in claim 11, wherein the identification of the area having local traffic routing is performed on the basis of a destination specification in a navigation system or on the basis of a currently traveled route or a current position of the vehicle.

14. The method as recited in claim 11, wherein the guidance system application may be downloaded automatically without asking a driver of the motor vehicle or after prior confirmation from the driver, and when crossing a minimum distance en route to the area of local traffic routing, immediately when entering the area of local traffic routing, or at the beginning of a drive having a known destination at which the area having the local traffic routing is located.

15. The method as recited in claim 11, wherein the guidance system application is downloaded only if it is determined that there exists no interface to the guidance system of the identified area of local traffic routing.

16. The method as recited in claim 11, wherein the use of the communication interface makes it possible automatically to signal to a driver driving recommendations or to move the vehicle in fully automatic fashion along the local traffic routes.

17. The method as recited in claim 11, wherein, when it is determined that the motor vehicle has left the area of the local traffic routing, the guidance system application is automatically uninstalled from the driver assistance system.

18. A driver assistance system in a motor vehicle for interaction with a local guidance system, the driver assistance system configured to:
identify an area having local traffic routing;
download a guidance system application or parameters for an existing guidance system application in order to create a communication interface with the local guidance system that is associated with the identified area of local traffic routing; and
use the communication interface for communication of the driver assistance system with the local guidance system when the motor vehicle is located within the area of the local traffic routing.

19. A non-transitory machine-readable storage medium on which is stored a computer program for the interaction of a driver assistance system in a motor vehicle with a local guidance system, the computer program, when executed by a computer, causing the computer to perform:
identifying an area having local traffic routing;
downloading a guidance system application or parameters for an existing guidance system application to create a communication interface with the local guidance system that is associated with the identified area of local traffic routing; and
using the communication interface for communication of the driver assistance system with the local guidance system when the motor vehicle is located within the area having local traffic routing.
